(19) United States
(12) Patent Application Publication
(10) Pub. No.: US 2023/0242420 A1
(43) Pub. Date: Aug. 3, 2023

(54) SYSTEM AND METHOD FOR WATER TREATMENT WITH VENTURI PLASMA DISCHARGE

(71) Applicant: Onvector LLC, King of Prussia, PA (US)

(72) Inventors: Daniel J. Cho, Elkins Park, PA (US); Russel R. McAvoy, Sharon, MA (US)

(21) Appl. No.: 18/013,786

(22) PCT Filed: Jun. 29, 2021
(86) PCT No.: PCT/US21/39499

§ 371 Date: Dec. 29, 2022

Related U.S. Application Data
(60) Provisional application No. 63/102,788, filed on Jun. 30, 2020.

(51) Int. Cl. C02F 1/46; B01F 33/05; B01F 25/312; C02F 1/461

(52) U.S. Cl. CPC C02F 1/4608; B01F 33/051; B01F 25/31242; C02F 2001/46157; C02F 2001/46171; C02F 2305/023

(57) ABSTRACT

A water treatment system includes a venturi injector including a venturi inlet that intakes water to be treated, a venturi throat including an orifice in fluid communication with a gas source, a discharge electrode integrated into a gas inlet in fluid communication with the orifice for generating a plasma discharge, thereby producing treated water, and a venturi outlet that discharges the treated water.

### CROSS-REFERENCE TO RELATED APPLICATIONS

This application claims the benefit of U.S. Provisional Application No. 63/102,788, filed Jun. 30, 2020, which is hereby incorporated by reference in its entirety.

### BACKGROUND

Oil and gas production processes generate large volumes of liquid waste. For example, hydraulic fracturing of shale utilizes large volumes of high-pressure water to fracture shale formation. The wastewater generated during the drilling phase is called flowback water, whereas the water generated during the production phase is called produced water. Both the flowback and produced waters contain various organic and inorganic components, and discharging produced water can pollute surface and underground water and soil. Since approximately 250 million barrels per day (i.e., ˜30 million m³ per day) of produced water are generated globally (see F. I.-R. Ahmadun et al., “Review of technologies for oil and gas produced water treatment,” J. Hazard. Mater., vol. 170, pp. 530-551, 2009), an amount that is expected to continue increasing for an extended period of time, there is a growing need for new methods to treat large volumes of produced water robustly and efficiently. With volatility in the prices of oil and gas, there is a pressing parallel need to reduce the costs of production, including produced water treatment costs.

A variety of methods are currently utilized to treat produced water for the purposes of discharge as well as for recycling and reuse in subsequent hydraulic fracturing operations. This diverse set of water treatment techniques include de-oiling (removing dispersed oil and grease), removal of soluble organics, disinfection, suspended solid particle removal, dissolved gas removal (including hydrocarbon gases, carbon dioxide, and hydrogen sulfide), desalination (removing sodium and chloride ions), and water-softening (reducing calcium and magnesium hardness), among others (see F. I.-R. Ahmadun et al.). Similar water treatment targets can be found in a range of applications cases, other than produced and flowback waters, such as industrial wastewater or process water pre-treatment for discharge or beneficial reuse, municipal wastewater for irrigation reuse, and well water treatment for residential or light commercial use, among others.

Plasma arc discharge generates a significantly elevated temperature beyond 2,000 K around the arc (see A. Czernichowski et al., “Spectral and electrical diagnostics of gliding arc,” Acta Physica Polonica-Series A General Physics, vol. 89, pp. 595-604, 1996; and O. Mutaf-Yardimci et al., “Thermal and nonthermal regimes of gliding arc discharge in air flow,” Journal of Applied Physics, vol. 87, pp. 1632-1641, 2000). In addition, plasma discharge generates active plasma species directly in liquid, i.e., OH, O, O₃, H₂O₂, NOₓ, UV and electric fields. Thus, if one can successfully generate plasma discharge in produced water, the plasma discharge can be applied for the removal of dispersed oil/grease and soluble hydrocarbons (see N. McIntyre et al., “Uses of ultraviolet/ozone for hydrocarbon removal: Applications to surfaces of complex composition or geometry,” J. Vac. Sci. Technol., A: Vacuum, Surfaces, and Films, vol. 9, pp. 1355-1359, 1991), water softening (see Y. Yang et al., “Removal of CaCO₃ scales on a filter membrane using plasma discharge in water,” Int. J. Heat Mass Transfer, vol. 52, pp. 4901-4906, 2009; and Y. Yang et al., “Mineral Fouling Control by Underwater Plasma Discharge in a Heat Exchanger,” J. Heat Transfer, vol. 133, p. 054502, 2011), and disinfection (see H.-S. Kim et al., “Concentration of hydrogen peroxide generated by gliding arc discharge and inactivation of E. coli in water,” Int. Commun. Heat Mass Transfer, vol. 42, pp. 5-10, 2013). These active plasma treatment species may be employed for produced and flowback water from oil and gas exploration as well as, more broadly, wastewater streams from municipalities and a number of other industrial processes.

When a voltage gradient (1 kV/cm or more) is applied across two electrodes (i.e., anode and cathode) separated by approximately 1 cm, free-flowing electrons break down the air, and a plasma discharge takes place with the appearance of lightning. The electrons can also break down low-electric-conductivity liquid (i.e. liquid with a conductivity of 0.1 mS/cm or less) in a similar manner, generating plasma within the liquid matrix. See Yang, Y., et al., Application of pulsed spark discharge for calcium carbonate precipitation in hard water. Water Res., 2010. 44: p. 3659-3668; Yang, Y., Y. I. Cho, and A. Fridman, Plasma Discharge in Liquid: Water Treatment and Applications. 2012, New York: CRC Press; and Kim, H. S., et al., Use of plasma gliding arc discharges on the inactivation of E. Coli in water. Separation Purification Technology, 2013. 120: p. 423-428.

However, when the conductivity of the liquid is higher, such as the conductivity in excess of 10 mS/cm of industrial wastewater, seawater, and produced water, the water itself behaves as an electric conductor. To overcome the adverse effect of high conductivity, one needs to have an airgap between anode and cathode, or at least an airgap around the discharge (i.e., high-voltage) electrode. One of the methods to provide such an airgap is to use a vortex flow of liquid in a cylindrical reactor geometry. The vortex flow creates a low-pressure zone at the center of the reactor, where compressed gas is injected through multiple holes on the side wall of the discharge electrode. See U.S. application Ser. No. 16/258,734 filed on Jan. 28, 2019, entitled “System and Method for Plasma Discharge in Liquid,” published on Aug. 8, 2019 as US 2019/0241447 A1.

As the discharge electrode (i.e., anode) is surrounded by gas in a liquid reactor, plasma (either spark or arc plasma) is generated. The compressed gas in a plasma vortex system not only helps the generation of plasma but also stretches the arc vertically upward, enlarging the physical size of the arc. Furthermore, the injected gas also cools the discharge electrode, reducing the risk of electrode erosion caused by focal regions of high-temperature from the plasma arc. In addition, the vortex flow of water forces the arc to glide around the circular edge of the discharge electrode, an extremely useful process that continuously cools the electrode.

In one implementation of the plasma vortex system, the discharge electrode is located at the bottom end of the cylindrical reactor with the ground electrode at the top end such that the heat energy from the plasma moves away from the discharge electrode. From Ohm's law (i.e., V=iR), the current during plasma discharge is determined by the impedance between the two electrodes, which depends not only on the distance between the two electrodes but also on the conductivity of the liquid. Accordingly, the plasma power supply should be designed to be able to handle the changing impedance due to the changing electric conductivity of the liquid.

Once a pulsed plasma arc (at 20-30 kHz) is suspended in the plasma vortex reactor, a steady supply of reactive oxygen/nitrogen species are generated (i.e., ¹O₂, OH^{.}, H^{.}, O^{.}, HO₂^{.}, O₂⁻, O₃, H₂O₂, N^{.}, NOₓ, NO^{.} and charged particles). These oxidizing agents react with and break down organic bonds (C—H, C—C, C═C, C—O, C—N) and inorganic contaminants in liquid. As the half-lives of most reactive species other than ozone are very short, it is essential to have plasma discharge inside water. See Yang, Y., Y. I. Cho, and A. Fridman, Plasma Discharge in Liquid: Water Treatment and Applications. 2012, New York: CRC Press. Furthermore, the aforementioned stretched arc provides a longer contact time and a greater contact surface between the water to be treated and the reactive species. In addition, the UV radiation from the plasma acts as a potent disinfectant, killing and preventing reproduction of bacteria and viruses, without any lamp surface to accumulate biofilm or degrade transmission. See Hijnen, W., E. Beerendonk, and G. J. Medema, Inactivation credit of UV radiation for viruses, bacteria and protozoan (oo) cysts in water: a review. Water research, 2006. 40(1): p. 3-22.

Two shortcomings of the vortex-flow based plasma discharge are a large pressure drop and a large volume of gas needed to provide the airgap around the discharge electrode. Furthermore, due to the centrifugal force generated by the vortex flow, liquid tends to be thrown out along the radial direction in the reactor, whereas the gas remains at the center of the reactor. Naturally, liquid and gas do not get mixed, but rather stay separated. Since the gas contains several useful active plasma species, efficient mixing of liquid and gas would be helpful in enhancing the plasma treatment of water or wastewater.

Therefore, there is a need for a plasma generation method in liquid that requires a smaller pressure drop, a smaller volume of gas, a smaller footprint, and improved mixing between liquid and gas, resulting in continuing improvement in water treatment with pulsed spark or arc discharges with a disinfecting capability for water, river water, seawater, well water, industrial or municipal wastewater, industrial process water, and produced or flowback water from fracking operations.

### SUMMARY

Various embodiments disclosed herein relate to methods and apparatus for water treatment with venturi plasma discharges. In accordance with one or more embodiments, a water treatment system includes a venturi injector including a venturi inlet that intakes water to be treated, a venturi throat including an orifice in fluid communication with a gas source, a discharge electrode integrated into a gas inlet in fluid communication with the orifice for generating a plasma discharge, thereby producing treated water, and a venturi outlet that discharges the treated water. In some embodiments, the discharge electrode can be a cylindrical discharge electrode. In certain embodiments, the venturi throat can be coaxial with the discharge electrode. In some embodiments, the cylindrical discharge electrode can be a hollow cylindrical discharge electrode. In some of these embodiments, the hollow cylindrical discharge electrode can further include an endcap and a plurality of side openings in the cylinder wall. In certain embodiments, the endcap can further include a central opening. In other embodiments, the cylindrical discharge electrode can be a solid rod. In certain embodiments, the venturi inlet can include a taper in fluid communication with the venturi throat. In some embodiments, the water treatment system can further include a cylindrical insulator around the cylindrical discharge electrode. In some of these embodiments, the venturi outlet can be a ground electrode. In some other embodiments, the water treatment system can further include a ground electrode disposed upstream of the venturi throat. In these specific embodiments, the water to be treated can have an electrical conductivity in a range of between 0.1 mS/cm and 10 mS/cm. In certain other embodiments, the water treatment system can further include a ground electrode disposed downstream of the venturi throat. In these specific embodiments, the water to be treated can have an electrical conductivity in a range of between 10 mS/cm and 250 mS/cm. In certain embodiments, the water treatment system can further include a ground electrode disposed within the venturi throat. In some embodiments, the water to be treated can have an electrical conductivity in a range of between 0.1 mS/cm and 250 mS/cm. In certain embodiments, the gas can include gas to be treated. In some embodiments, the discharge electrode can be a cylindrical discharge electrode having side openings in the cylinder wall. In some of these specific embodiments, the discharge electrode can further include a central opening in fluid communication with the gas inlet. In certain of these specific embodiments, the water treatment system can further include a cylindrical insulator around the cylindrical discharge electrode, and an airgap between the cylindrical insulator and the cylindrical discharge electrode. In some of these specific embodiments, the venturi injector can be a ground electrode. In certain embodiments, the venturi outlet can discharge the treated water into a water holding tank in fluid communication with the venturi inlet. In some embodiments, the water treatment system can further include a gas recirculation system in fluid communication with the gas source.

In accordance with one or more embodiments, a method of water treatment includes flowing water to be treated through a venturi inlet to a venturi throat including an orifice in fluid communication with a gas source, the venturi throat including a discharge electrode integrated into a gas inlet in fluid communication with the orifice, flowing gas from the gas source through side openings in the discharge electrode, and generating a plasma discharge, thereby producing treated water. In some embodiments, the method can further include recirculating the gas to the gas source. In certain embodiments, the method can further include recirculating the treated water to the venturi inlet.

The water treatment systems and methods described herein have many advantages, including a smaller pressure drop, a smaller volume of gas, a smaller footprint, and improved mixing as compared to the plasma vortex system.

### BRIEF DESCRIPTION OF THE DRAWINGS

The foregoing purposes and features, as well as other purposes and features, will become apparent with reference to the description and accompanying figures below, which are included to provide an understanding of the invention and constitute a part of the specification, in which like numerals represent like elements. The figures are not necessarily drawn to scale, emphasis instead being placed upon illustrating embodiments.

FIGS. 1A-1D are simplified cross-section views of a plasma venturi water treatment system in accordance with one or more embodiments.

FIG. 2 is a simplified perspective view of a discharge electrode for a plasma venturi water treatment system in accordance with one or more embodiments.

FIGS. 3A-3D are simplified cross-section views of another plasma venturi water treatment system in accordance with one or more embodiments.

FIG. 3E is a simplified top view of a tangential venturi inlet in accordance with one or more embodiments.

FIG. 4 is a graph of the pressure at the venturi throat (psig) as a function of the ratio between the venturi throat diameter D₂ and the venturi inlet diameter D₁ in accordance with one or more embodiments.

FIG. 5 is a simplified cross-section view of a plasma venturi water treatment system including an untreated water holding tank and a gas recirculation system in accordance with one or more embodiments.

FIG. 6 is a simplified cross-section view of a plasma venturi water treatment system including an untreated water holding tank, a treated water holding tank, and a gas recirculation system in accordance with one or more embodiments.

FIG. 7 is a simplified perspective view of a plasma venturi water treatment system for bio-decontamination or disinfection of water used for irrigation, such as drip irrigation, in accordance with one or more embodiments.

FIG. 8A is a photograph of a plasma venturi water treatment system with plasma discharge off in accordance with one or more embodiments.

FIG. 8B is a photograph of a plasma venturi water treatment system with plasma discharge on in accordance with one or more embodiments.

FIG. 9 a flow chart of a method of treating water with a plasma venturi water treatment system in accordance with one or more embodiments.

### DETAILED DESCRIPTION

It is to be understood that the figures and descriptions of the present invention have been simplified to illustrate elements that are relevant for a clearer comprehension of the present invention, while eliminating, for the purpose of clarity, many other elements found in systems and methods of plasma discharge in liquid. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, and ±0.1% from the specified value, as such variations are appropriate.

“HV” as used herein means high-voltage, such as a voltage in excess of 1,000 V.

Ranges: throughout this disclosure, various aspects of the invention can be presented in a range format. It should be understood that the description in range format is merely for convenience and brevity and should not be construed as an inflexible limitation on the scope of the invention. Where appropriate, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

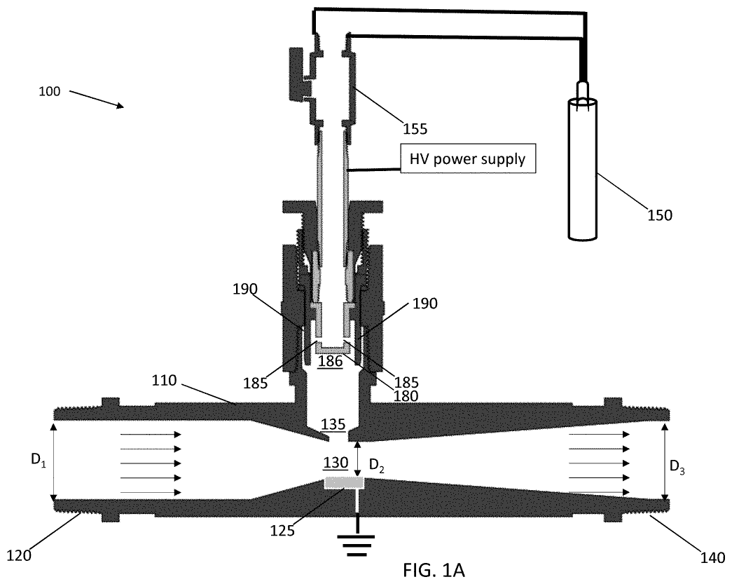

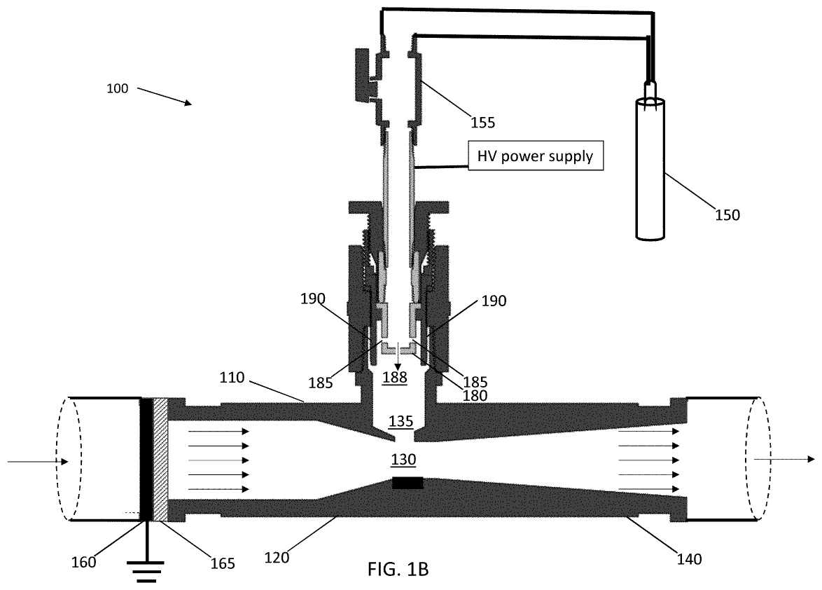

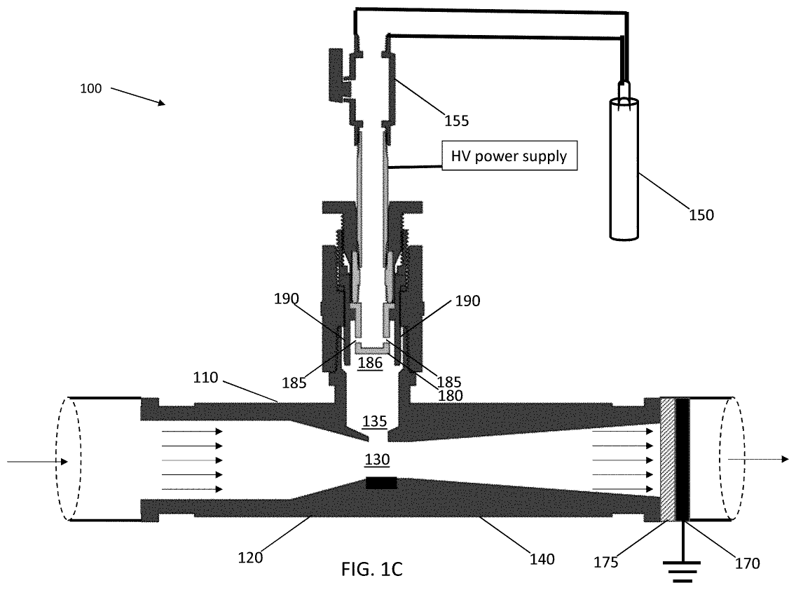

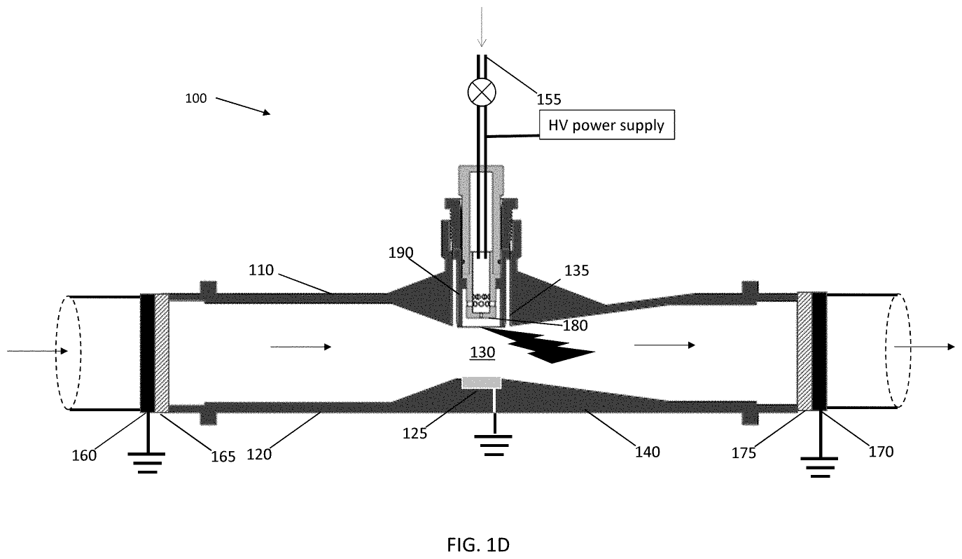

The objective of the systems and methods described herein is to disinfect various types of liquids, including water, river/lake water, seawater, well water, industrial or municipal wastewater, industrial process water, and produced or flowback water from fracking operations, and to remove contaminants in wastewater and leachates and oxidize and decompose them without leaving any treatment gap or secondary waste problems. Various embodiments disclosed herein relate to methods and apparatus for water treatment with venturi plasma discharges. In accordance with one or more embodiments, as shown in FIG. 1A, a water treatment system 100 includes a venturi injector 110 that has a cylindrical tubular geometry where a cross-sectional area of the injector 110 is gradually reduced at the venturi inlet 120 from an initial diameter D₁ and then gradually increased at the venturi outlet 140 to a final diameter D₃ in order to minimize pressure drop. Note that the diameter D₃ of the venturi outlet 140 is typically equal to the diameter D₁ of the venturi inlet 120, although other choices of D₁ and D₃ are possible. See Mazzei Injector Company LLC, Bakersfield, Calif. The reduced cross-sectional area 130 having a diameter D₂ is often called the venturi throat 130, where the fluid pressure is reduced as the fluid velocity increases according to the Bernoulli principle. See Munson, B., et al., Fundamentals of Fluid Mechanics. 7th ed. 2013, New York: John Wiley & Sons, Inc. Thus, the pressure at the venturi throat 130 is always less than the inlet liquid pressure due to the reduced cross-sectional area. Hence, when the inlet liquid flow velocity increases, the pressure at the venturi throat 130 decreases accordingly. In addition, when the cross-sectional area of the throat is reduced, the pressure at the venturi throat 130 also decreases. Since the venturi throat pressure can be relatively easily adjusted, the venturi injector 110 can be considered as a method to generate HV plasma discharge in liquid. There are several characteristics of venturi flow that may be useful in the generation of plasma in liquid.

The pressure at the throat 130 can be decreased well below the inlet pressure of liquid. Therefore, the venturi throat 130 is an ideal location where air or other gases can be injected through an orifice 135 in fluid communication with a gas source 150. Depending on the level of the throat pressure, it may be possible to inject gas without the use of a compressor.

Air (or gas) is introduced into the venturi system 100 from gas source 150 through the gas inlet 155 that is in fluid communication with the orifice 135 in order to provide an airgap 186 around the discharge electrode 180, a necessary condition for plasma discharge inside water. The introduction of air into the venturi system 100 generally takes place due to the reduced pressure at the throat 130, which can be explained by the Bernoulli principle. The Bernoulli equation relates the pressure and flow velocity along a streamline as follows:

$${P}_{1} + \frac{1}{2} ρ {V}_{1}^{2} + ρ {Z}_{1} = {P}_{2} + \frac{1}{2} ρ {V}_{2}^{2} + ρ {Z}_{2} , \qquad ( 1 )$$

where P₁ and P₂ are gauge pressures (psig) at the venturi inlet 120 and throat 130, respectively, V₁ and V₂ are flow velocities (ft/s) at the venturi inlet 120 and throat 130, respectively, and ρ is the density of water. When the venturi injector 110 is positioned horizontally, the height change is negligible, i.e., Z₁=Z₂. Furthermore, V₁ and V₂ are determined by the cross-sectional areas at the venturi inlet 120 and throat 130, respectively. For example, if the venturi inlet diameter is D₁ and the throat diameter is D₂, then one has the following relation between the two flow velocities:

V₁D₁²=V₂D₂² (2)

Hence, by substituting V₂ with

$${V}_{1} [ {( \frac{{D}_{1}}{{D}_{2}} )}^{2} ]$$

into the above Bernoulli equation, the pressure at the throat 130 becomes:

$${P}_{2} = {P}_{1} + \frac{1}{2} ρ {V}_{1}^{2} [ 1 - {( \frac{{D}_{1}}{{D}_{2}} )}^{4} ] \qquad ( 3 )$$

As an example, consider a water treatment system 100 with a 2″ inlet diameter D₁ that delivers a flowrate of approximately 100 gallons per minute (gpm) at an inlet pressure of 40 psig. Note that a flowrate of 100 gpm in a 2″ diameter pipe delivers a flow velocity V₁ of 10.2 ft/s. When the throat diameter D₂ is 0.8″, i.e., D₂/D₁=0.4, then the pressure decreases to approximately 13 psig as shown in FIG. 4.

If the throat diameter D₂further decreases to 0.7″, i.e., D₂/D₁=0.35, then, as shown in FIG. 4, the pressure decreases to −6 psig (i.e., a strong vacuum pressure), a significant drop in the throat pressure, with even stronger vacuum pressures possible at lower values of D₂/D₁. Such a drop in the throat pressure can significantly increase the air flow through the orifice 135 at the venturi throat 130 without a compressor.

Once air or gas (optionally including droplets, dust, or other aerosolized solids) is injected to liquid through the orifice 135 at the throat 130, the bulk air is broken into a number of small-size air bubbles due to high liquid velocity at the throat 130, providing improved mixing between liquid and air, as compared to the plasma vortex, thereby enhancing the plasma treatment of the liquid.

The pressure drop in liquid flow is significantly less in the venturi plasma system than in the plasma vortex system. This is due to the fact that in the plasma vortex system the liquid pressure at the exit of the plasma reactor falls to zero gauge pressure due to the centrifugal motion of vortex flow. In contrast, the pressure of liquid at the exit of the venturi injector 110 is still significantly greater than zero gauge pressure because the liquid pressure recovers at the venturi outlet 140 according to the Bernoulli principle, as the cross-sectional area of the exit of the venturi injector 110 is increased.

The flow reactor geometry of the venturi plasma system is a tubular configuration compared to the three-dimensional geometry of the plasma vortex system. Hence, the venturi plasma system is simple in construction and has a small footprint with a smaller pressure drop in connecting pipes, as compared to the plasma vortex system.

In order to generate a plasma discharge in liquid, one needs to have the ground electrode in the reactor. In the venturi plasma system, one can consider a ground electrode 125 disposed within the venturi throat 130, as shown in FIG. 1A, or upstream, i.e., a ground ring electrode 160 near the venturi inlet 120, as shown in FIG. 1B, along with an insulation ring 165 provided if the venturi injector 110 is made of metal or other conductive material, as described further below. Alternatively, one can consider a ground electrode downstream, i.e., a ground ring electrode 170 near the venturi outlet 140, as shown in FIG. 10, along with an insulation ring 175 provided if the venturi injector 110 is made of metal or other conductive material, as described further below. Since the impedance in the plasma circuit is approximately the sum of the airgap resistance and the resistance of liquid, the conductivity of liquid becomes the essential component in the impedance. When the downstream ground 170 is used, the conductivity of liquid can be significantly greater (e.g., 10 mS/cm-250 mS/cm) as a large number of small gas bubbles are dispersed in the liquid, reducing the effective conductivity of the liquid-gas mixture. Accordingly, the impedance increases due to the presence of dispersed gas bubbles with the ground 170 located downstream. On the other hand, when the upstream ground 160 is used, there are almost no gas bubbles in the liquid, and thus the impedance is small and therefore suitable for low conductivity (e.g., 0.1 mS/cm-10 mS/cm) liquid. Hence, the positions 160 or 170 of the ground electrode can be utilized to optimize the plasma impedance depending on the electric conductivity of the liquid.

As shown in FIGS. 1A-1C, the discharge electrode 180 is integrated into the gas inlet 155. In some embodiments, the discharge electrode 180 is a cylindrical discharge electrode having side openings 185 in the cylinder wall. The holes 185 on the side wall of the discharge electrode 180 provide an airgap 186 (not shown in FIG. 1B for clarity) around the discharge electrode 180. For example, in one embodiment, there are 16 circular holes 185 with inside diameters of 3 mm on the side wall of the discharge electrode 180 whose outside diameter is 32 mm. Optionally, as shown in FIG. 1B, the end wall of the discharge electrode 180 has one axially centered circular hole 188 with an inside diameter of, for example, 3 mm for air flow. Hence, the sum of all the openings of the side holes 185 accounts for approximately 94%, while the opening of the hole 188 at the end wall accounts for 6%. In other words, most of the gas that is introduced through the gas inlet 155 at the throat 130 flows through the holes 185 on the side wall. Benefits of the large flow through side holes 185 include the efficient cooling of the discharge electrode 180 and the stable airgap 186 between the discharge electrode 180 and the cylindrical insulator 190.

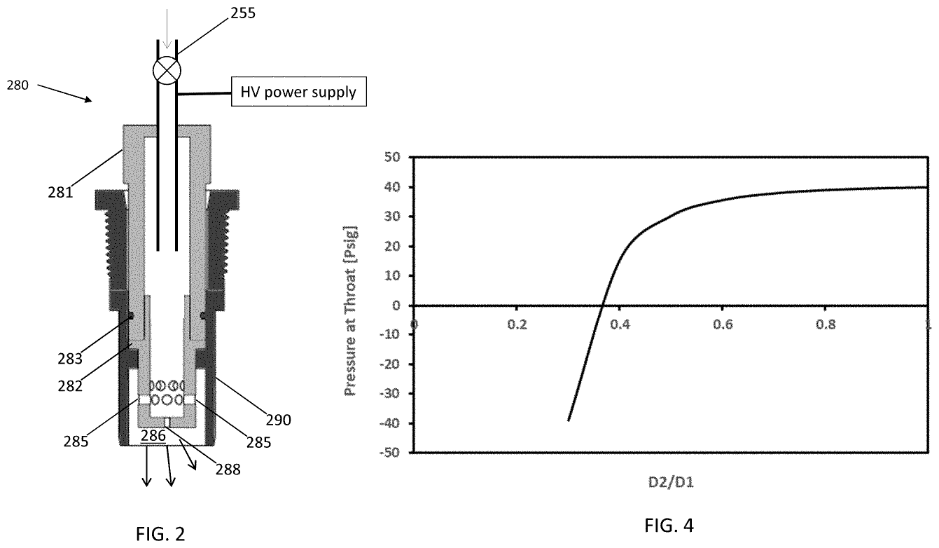

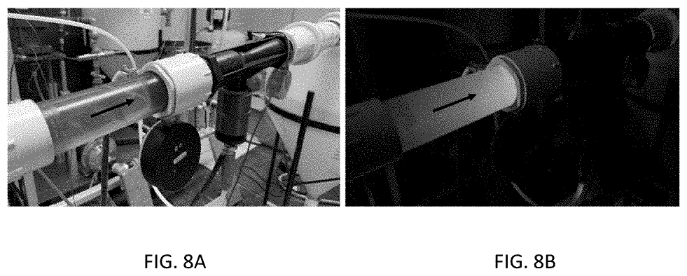

As shown in FIG. 1D, the orifice 135 can be bored out such that the discharge electrode 180 is disposed further into the venturi throat 130. The three ground electrodes 125, 160, and 170 are also shown in FIG. 1D. The discharge electrode 280, shown in detail in FIG. 2, can be made in two parts 281 and 282, such that the part 282 that is closest to the plasma discharge can be made of titanium or other erosion- and temperature-resistant metal, and the other part 281 can be made of an easier to machine metal, such as aluminum. An o-ring 283 provides the gastight seal between the gas supply 255 and the cylindrical insulator 290. As discussed above, gas flowing through the side openings 285, shown in perspective in FIG. 2 in order to show the multiple side openings discussed above, sweeps out an airgap 286 around the discharge electrode 282 within the lower portion of the cylindrical insulator 290, and the central opening 288 provides additional gas flow. The cylindrical insulator 290 can be made of ceramic or other electrical insulator material suitable for use at high temperature. The discharge electrode 280 can also be oriented upward by orienting the plasma treatment system shown in FIGS. 1A-1D upside down (see photograph shown in FIG. 8A). Turning back to FIG. 1A, the venturi injector 110 can be the ground electrode 125, either by having the venturi injector 110 be made of an electrical insulator material, such as plastic, and the ground electrode 125 disposed within the venturi throat 130, or by having the venturi injector 110 made of metal or other electrically conductive material.

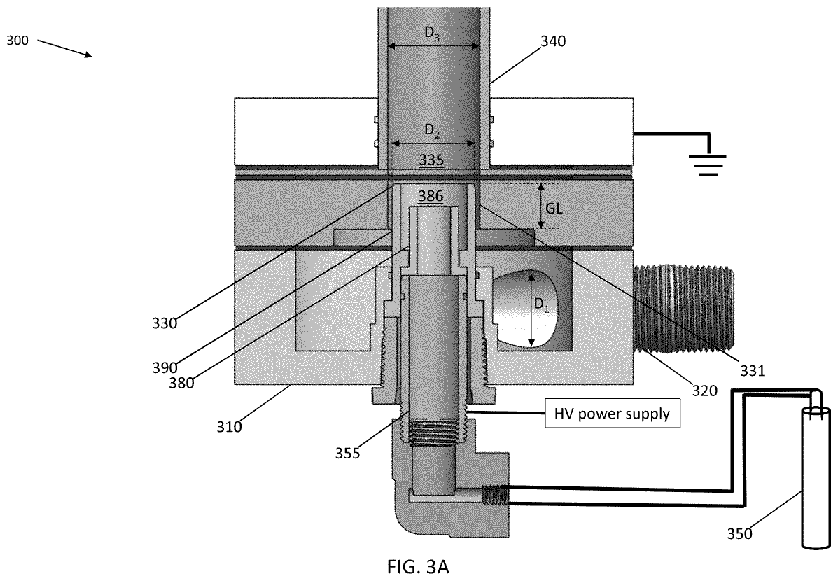

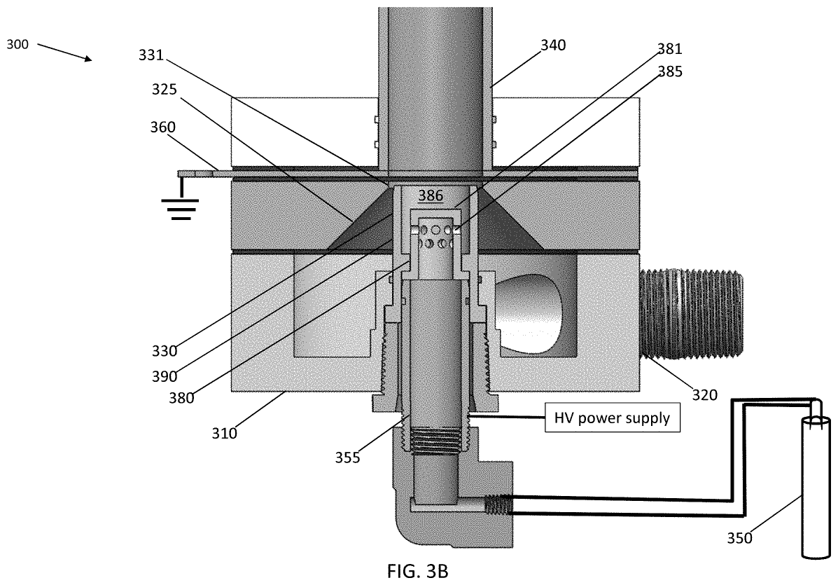

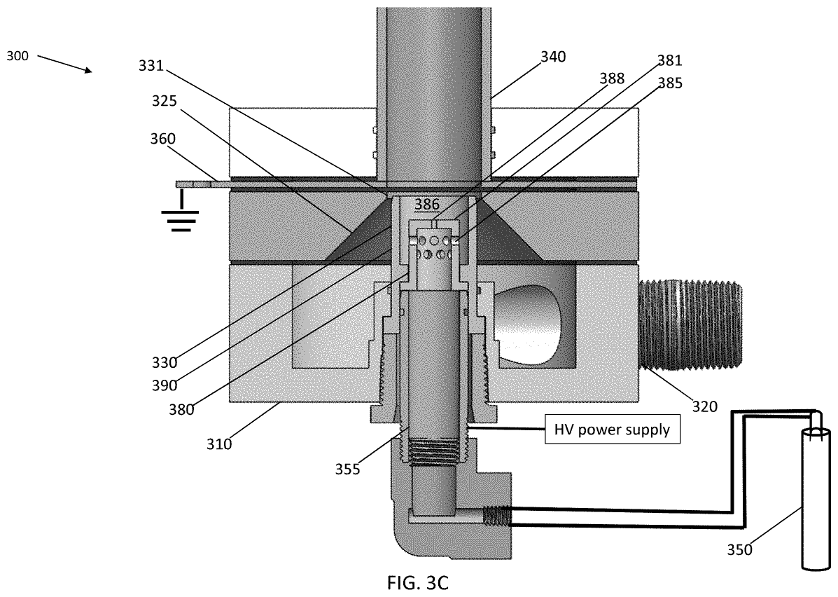

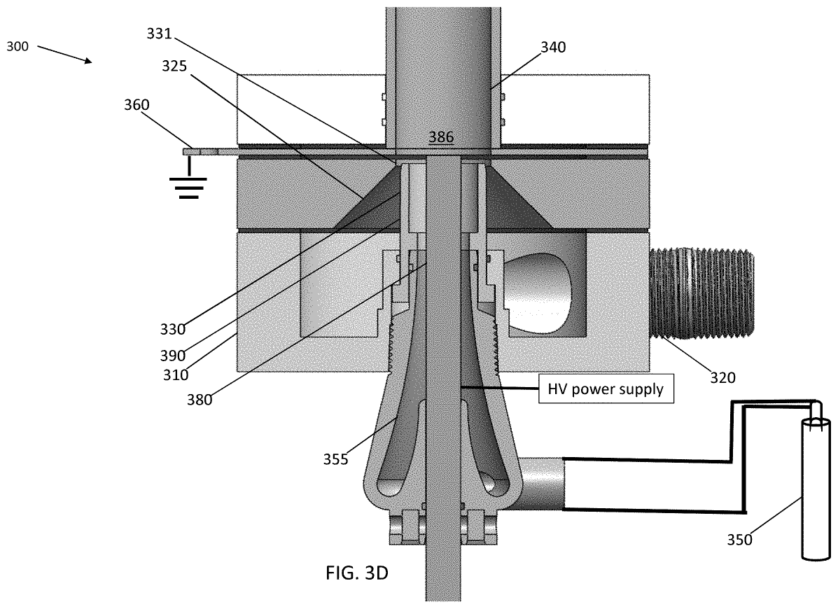

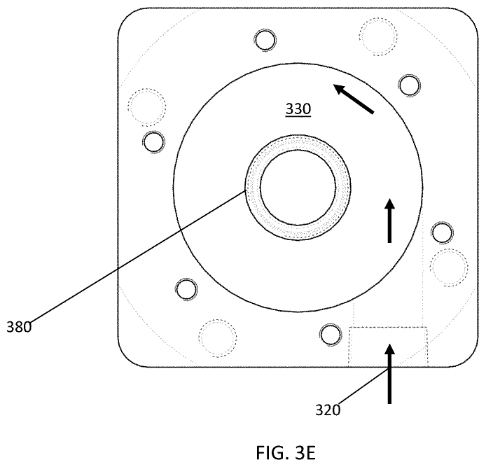

In accordance with one or more embodiments, as shown in FIG. 3A, a water treatment system 300 includes a venturi injector 310 that has a cylindrical tubular geometry where a cross-sectional area of the injector 310 is gradually reduced at the venturi inlet 320 from an initial diameter D₁ and then increased at the venturi outlet 340 to a final diameter D₃. The reduced cross-sectional area venturi throat 330 having a diameter D₂ is coaxial with the discharge electrode 380. The pressure at the throat 330 can be decreased well below the inlet pressure of liquid, and therefore air or other gases can be injected, due to the reduced pressure at the throat 330 due to the Bernoulli principle described above, through an orifice 335 in fluid communication with a gas source 350. Air (or gas) is introduced into the venturi system 300 from gas source 350 through the gas inlet 355 that is in fluid communication with the orifice 335 in order to provide an airgap 386 around the discharge electrode 380, a necessary condition for plasma discharge inside water. The discharge electrode 380 is integrated into the gas inlet 355, and the orifice 335 is bored out such that the discharge electrode 380 is disposed in the venturi throat 330. In some embodiments, the discharge electrode 380 is a cylindrical discharge electrode. As shown in FIG. 3A, the discharge electrode can be a hollow cylindrical discharge electrode 380. In another aspect, as shown in FIG. 3B, the hollow cylindrical discharge electrode 380 includes an endcap 381 and a plurality of side openings 385 in the cylinder wall. Optionally, as shown in FIG. 3C, the endcap 381 includes a central opening 388. In yet another aspect, as shown in FIG. 3D, the cylindrical discharge electrode 380 is a solid rod 380. In embodiments using a solid rod electrode 380, gas flows around the outside of the electrode 380 rather than through its interior. This gas flow can be parallel with the axis of the electrode 380, or it can have a non-zero angular component to its velocity and thereby move along helical streamlines. In such cases, the rotating gas flow may have either right-handed or left-handed chirality. In embodiments where both the gas flow and the liquid flow have non-zero angular velocity, the gas flow and liquid flow may have either the same chirality (co-rotating) or the opposite chirality (counter-rotating). As shown in FIGS. 3A-3D, a cylindrical insulator 390 is disposed around the cylindrical discharge electrode 380. The cylindrical insulator 390 can be made of ceramic or other electrical insulator material suitable for use at high temperature.

In order to generate a plasma discharge in liquid, one needs to have the ground electrode disposed in the reactor, with the ground electrode in contact with the liquid. In the venturi plasma system 300, one can consider having the venturi outlet 340 grounded, as shown in FIG. 3A, or one can include a grounded metal plate 360 between the venturi inlet 320 and the venturi outlet 340, as shown in FIGS. 3B-3D. The grounded metal plate 360 enables the venturi outlet 340 to be made of a non-conductive, optionally transparent material, thereby making it possible to visually observe the plasma discharge.

Turning back to FIG. 3A, the venturi throat 330 can be in the form of an annular gap 331 having a gap length GL. In other embodiments, as shown in FIGS. 3B-3D, the venturi inlet 320 includes a taper 325 in fluid communication with the venturi throat 330. The taper 325 reduces the frictional pressure drop, as the axial gap length of the annular gap 331 is substantially reduced. The venturi inlet 320 can be axially perpendicular to the discharge electrode 380, or, as shown in FIG. 3E, the venturi inlet 320 can be oriented tangentially with respect to the discharge electrode 380. The optional taper (not shown) on the venturi inlet 320 leading to the venturi throat 330 maintains the circumferential liquid flow, while accelerating the velocity of the liquid.

As an example, turning back to FIG. 3A, consider a water treatment system 300 with a venturi inlet 320 diameter D₁=1″ that delivers a flow rate of approximately 100 gpm. When the venturi throat 330 diameter D₂=1.25″ and the venturi outlet 340 diameter D₃=1.5″, the hydraulic diameter of the annular gap Dₕ=D₃−D₂, for a gap length GL=0.5″, resulting in a pressure of −17.5 psig (i.e., a strong vacuum pressure). Such a drop in the throat pressure can significantly increase air flow through the orifice 335 at the venturi throat 330 without a compressor.

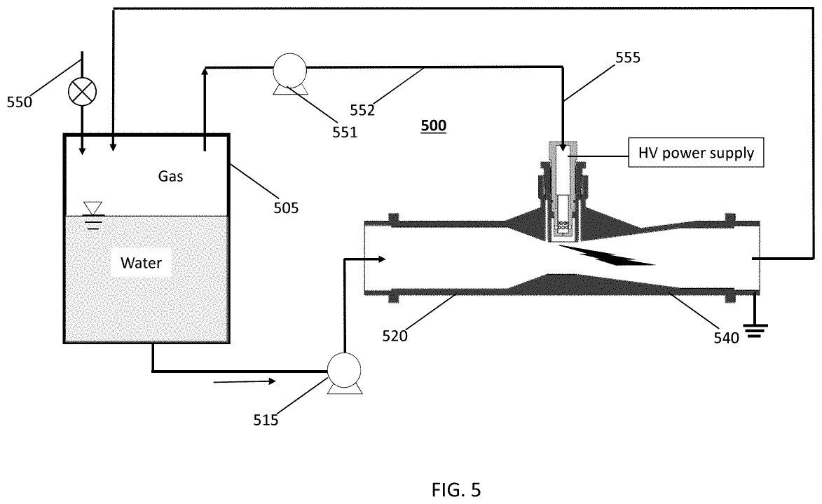

In accordance with one or more embodiments, as shown in FIG. 5, the venturi outlet 540 discharges the treated water into a water holding tank 505 in fluid communication with the venturi inlet 520, thereby recirculating the water to be treated. In some embodiments, the water treatment system 500 can further include a gas recirculation system 552 in fluid communication with the gas source 550, thereby combining gas to be treated from the top of the holding tank 505 with gas from the gas source 550, optionally compressed by gas compressor 551. The required water flow rate and water inlet pressure is provided by water pump 515.

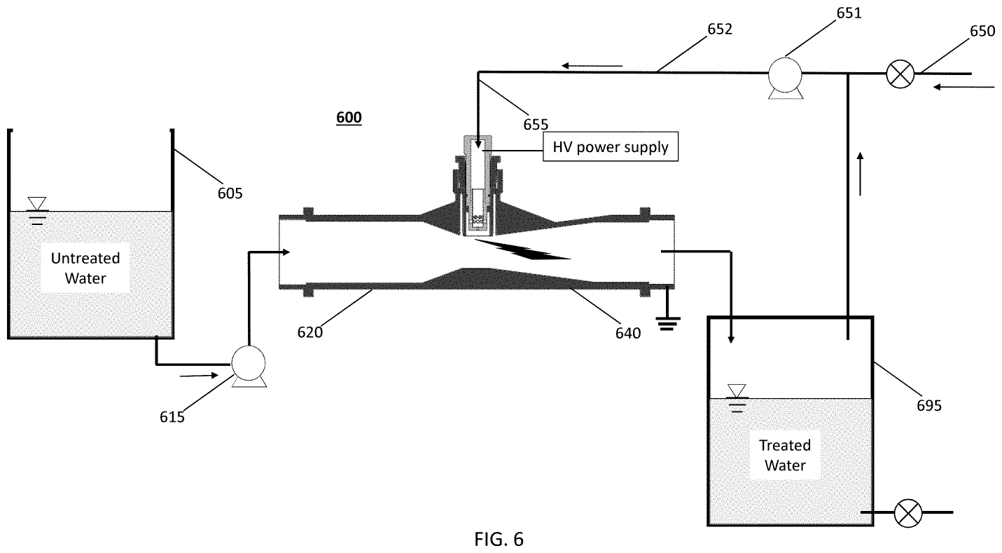

Alternatively, as shown in FIG. 6, the venturi outlet 640 of the water treatment 600 discharges the treated water into a water holding tank 695. Gas from the top of the treated water is combined with gas from gas source 650 in a gas recirculation system 652 in fluid communication with the gas inlet 655, thereby recirculating the gas to be treated, optionally compressed by gas compressor 651. The required water flow rate and water inlet pressure from untreated water holding tank 605 is provided by water pump 615 to venturi inlet 620.

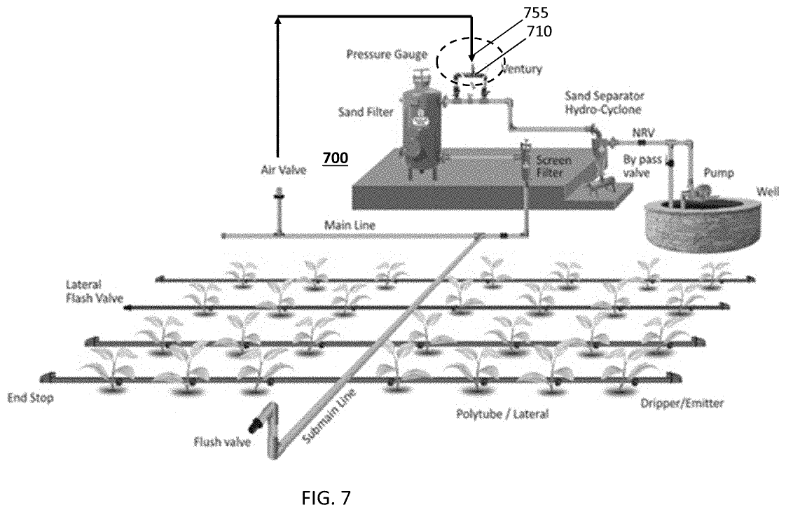

In accordance with one or more embodiments, as shown in FIG. 7, a plasma venturi system 700 is deployed for bio-decontamination or disinfection of water used for irrigation, especially for drip irrigation, wherein plant pathogens and biofouling of equipment such as emitters or drippers can be dramatically reduced or eliminated in order to improve agricultural yield, quality, and importantly, the performance and longevity of emitter technology. Plasma venturi technology will also simultaneously reduce mineral fouling or scaling, for example, calcium carbonate fouling through the application of electric fields for electro-flocculation of scale-forming salts. As shown in FIG. 7, air from within drip irrigation lines flows into gas inlet 755 of the venturi injector 710.

As shown in FIG. 8A, in one embodiment of the plasma venturi system, a water flow rate in a range of between 30 gpm and 38 gpm at 40 psig through a 2″ venturi injector having a venturi inlet diameter of about 40 mm and a D₂/D₁ ratio of about 0.35 produced a gas inlet rate of 2 CFM. As shown in FIG. 8B, a plasma discharge was produced, with a current in a range of between 2 A and 3 A (current-limited mode). Operating parameters include water flow rates in a range of between 30 gpm and 150 gpm, with corresponding gas inlet rates in a range of between 1 cfm and 15 cfm, at operating pressures in a range of between 40 psig and 120 psig, with plasma discharges with maximum currents of 4 A and maximum power of 8 kW.

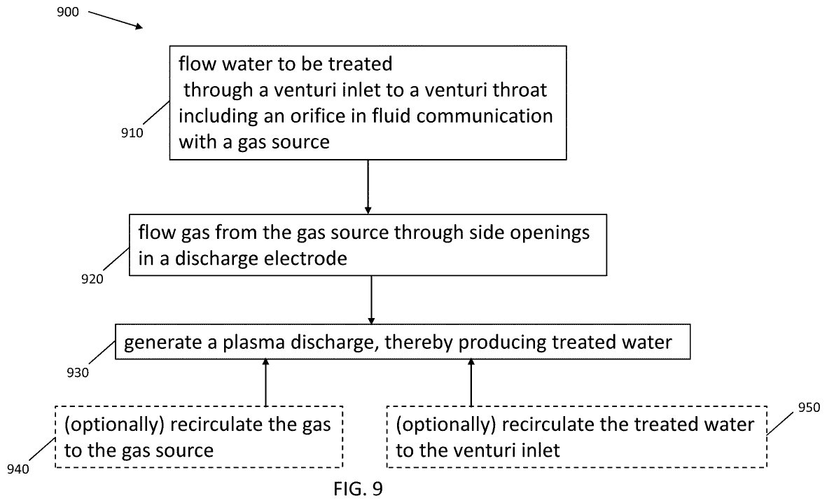

In accordance with one or more embodiments, as shown in FIG. 9, a method 900 of water treatment includes flowing 910 water to be treated through a venturi inlet to a venturi throat including an orifice in fluid communication with a gas source, the venturi throat including a discharge electrode integrated into a gas inlet in fluid communication with the orifice, flowing 920 gas from the gas source through side openings in the discharge electrode, and generating 930 a plasma discharge, thereby producing treated water. The gas flowing through side openings in the discharge electrode sweeps out an airgap between a cylindrical insulator and the cylindrical discharge electrode. In some embodiments, the method 900 can further include recirculating 940 the gas to the gas source. In certain embodiments, the method 800 can further include recirculating 950 the treated water to the venturi inlet.

### Further Example Embodiments

Example 1 is a water treatment system includes a venturi injector including a venturi inlet that intakes water to be treated, a venturi throat including an orifice in fluid communication with a gas source, a discharge electrode integrated into a gas inlet in fluid communication with the orifice for generating a plasma discharge, thereby producing treated water, and a venturi outlet that discharges the treated water.

Example 2 includes the subject matter of Example 1, further including a ground electrode disposed upstream of the venturi throat.

Example 3 includes the subject matter of any of Examples 1 or 2, wherein the water to be treated has an electrical conductivity in a range of between 0.1 mS/cm and 10 mS/cm.

Example 4 includes the subject matter of Example 1, further including a ground electrode disposed downstream of the venturi throat.

Example 5 includes the subject matter of Example 4, wherein the water to be treated has an electrical conductivity in a range of between 10 mS/cm and 250 mS/cm.

Example 6 includes the subject matter of Example 1, further including a ground electrode disposed within the venturi throat.

Example 7 includes the subject matter of Example 1, wherein the water to be treated has an electrical conductivity in a range of between 0.1 mS/cm and 250 mS/cm.

Example 8 includes the subject matter of any of Examples 1-7, wherein the gas includes gas to be treated.

Example 9 includes the subject matter of any of Examples 1-8, wherein the discharge electrode is a cylindrical discharge electrode having side openings in the cylinder wall.

Example 10 includes the subject matter of Example 9, wherein the discharge electrode further includes a central opening in fluid communication with the gas inlet.

Example 11 includes the subject matter of any of Examples 9-10, further including a cylindrical insulator around the cylindrical discharge electrode.

Example 12 includes the subject matter of Example 11, further including an airgap between the cylindrical insulator and the cylindrical discharge electrode.

Example 13 includes the subject matter of Example 11, wherein the venturi injector is a ground electrode.

Example 14 includes the subject matter of Example 1, wherein the discharge electrode is a cylindrical discharge electrode.

Example 15 includes the subject matter of Example 14, wherein the venturi throat is coaxial with the discharge electrode.

Example 16 includes the subject matter of Example 14, wherein the cylindrical discharge electrode is a hollow cylindrical discharge electrode.

Example 17 includes the subject matter of Example 16, wherein the hollow cylindrical discharge electrode further includes an endcap and a plurality of side openings in the cylinder wall.

Example 18 includes the subject matter of Example 17, wherein the endcap includes a central opening.

Example 19 includes the subject matter of Example 14, wherein the cylindrical discharge electrode is a solid rod.

Example 20 includes the subject matter of any of Examples 14-19, wherein the venturi inlet includes a taper in fluid communication with the venturi throat.

Example 21 includes the subject matter of any of Examples 14-19, further including a cylindrical insulator around the cylindrical discharge electrode.

Example 22 includes the subject matter of Example 21, wherein the venturi outlet is a ground electrode.

Example 23 includes the subject matter of any of Examples 1-22, wherein the venturi outlet discharges the treated water into a water holding tank in fluid communication with the venturi inlet.

Example 24 includes the subject matter of any of Examples 1-23, wherein the water treatment system further includes a gas recirculation system in fluid communication with the gas source.

Example 25 is a method of water treatment that includes flowing water to be treated through a venturi inlet to a venturi throat including an orifice in fluid communication with a gas source, the venturi throat including a discharge electrode integrated into a gas inlet in fluid communication with the orifice, flowing gas from the gas source through side openings in the discharge electrode, and generating a plasma discharge, thereby producing treated water.

Example 26 includes the subject matter of Example 25, wherein the gas flowing through side openings in the discharge electrode sweeps out an airgap between a cylindrical insulator and the cylindrical discharge electrode.

Example 27 includes the subject matter of any of Examples 25 or 26, further including recirculating the gas to the gas source.

Example 28 includes the subject matter of any of Examples 25-27, further including recirculating the treated water to the venturi inlet.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention.

What is claimed is:

1. A water treatment system comprising:
a venturi injector including a venturi inlet that intakes water to be treated;
a venturi throat including an orifice in fluid communication with a gas source;
a discharge electrode integrated into a gas inlet in fluid communication with the orifice for generating a plasma discharge, thereby producing treated water; and
a venturi outlet that discharges the treated water.

2. The water treatment system of claim 1, wherein the discharge electrode is a cylindrical discharge electrode.

3. The water treatment system of claim 2, wherein the venturi throat is coaxial with the discharge electrode.

4. The water treatment system of claim 2, wherein the cylindrical discharge electrode is a hollow cylindrical discharge electrode.

5. The water treatment system of claim 4, wherein the hollow cylindrical discharge electrode further includes an endcap and a plurality of side openings in the cylinder wall.

6. The water treatment system of claim 5, wherein the endcap includes a central opening.

7. The water treatment system of claim 2, wherein the cylindrical discharge electrode is a solid rod.

8. The water treatment system of claim 2, wherein the venturi inlet includes a taper in fluid communication with the venturi throat.

9. The water treatment system of claim 2, further including a cylindrical insulator around the cylindrical discharge electrode.

10. The water treatment system of claim 9, wherein the venturi outlet is a ground electrode.

11. The water treatment system of claim 1, further including a ground electrode disposed upstream of the venturi throat.

12. The water treatment system of claim 11, wherein the water to be treated has an electrical conductivity in a range of between 0.1 mS/cm and 10 mS/cm.

13. The water treatment system of claim 1, further including a ground electrode disposed downstream of the venturi throat.

14. The water treatment system of claim 13, wherein the water to be treated has an electrical conductivity in a range of between 10 mS/cm and 250 mS/cm.

15. The water treatment system of claim 1, further including a ground electrode disposed within the venturi throat.

16. The water treatment system of claim 1, wherein the water to be treated has an electrical conductivity in a range of between 0.1 mS/cm and 250 mS/cm.

17. The water treatment system of claim 1, wherein the gas includes gas to be treated.

18. The water treatment system of claim 1, wherein the discharge electrode is a cylindrical discharge electrode having side openings in the cylinder wall.

19. The water treatment system of claim 18, wherein the discharge electrode further includes a central opening in fluid communication with the gas inlet.

20. The water treatment system of claim 18, further including a cylindrical insulator around the cylindrical discharge electrode.

21. The water treatment system of claim 20, wherein the venturi injector is a ground electrode.

22. The water treatment system of claim 1, further including a gas recirculation system in fluid communication with the gas source.

23. The water treatment system of claim 1, wherein the venturi outlet discharges the treated water into a water holding tank in fluid communication with the venturi inlet.

24. The water treatment system of claim 23, further including a gas recirculation system in fluid communication with the gas source.

25. A method of water treatment comprising:
flowing water to be treated through a venturi inlet to a venturi throat including an orifice in fluid communication with a gas source, the venturi throat including a discharge electrode integrated into a gas inlet in fluid communication with the orifice;
flowing gas from the gas source through side openings in the discharge electrode; and
generating a plasma discharge, thereby producing treated water.

26. The method of claim 25, further including recirculating the gas to the gas source.

27. The method of claim 25, further including recirculating the treated water to the venturi inlet.
